(19) United States
(12) Patent Application Publication
(10) Pub. No.: US 2017/0346264 A1
(43) Pub. Date: Nov. 30, 2017

(54) Method And Apparatus For Performing Cable Lay And Connection Operations

(71) Applicant: Ecosse Subsea Systems Limited, Aberdeen Aberdeenshire (GB)

(72) Inventor: Michael Wilson, Banchory Aberdeenshire (GB)

(21) Appl. No.: 15/535,215

(22) PCT Filed: Nov. 10, 2015
(86) PCT No.: PCT/GB2015/053399

§ 371 Date: Jun. 12, 2017

(30) Foreign Application Priority Data
Dec. 12, 2014 (GB) 1422102.2

(51) Int. Cl. H02G 1/10; H02G 1/08

(52) U.S. Cl. CPC H02G 1/10; H02G 1/081; H02G 1/083

(57) ABSTRACT

The invention relates to a method of laying and connecting cable between a first structure and a second structure. The first and second structures may be turbine towers or other structures positioned in a body of water. The method includes the step of connecting a second end laying mechanism on the second structure for engagement with a second end portion of the cable. The second end portion of the cable is then engaged with the second end laying mechanism to form a catenary of cable at one side of the second end laying mechanism between the first and second structures, and a tail section at the other side of the second structure. The height of the second end laying mechanism is then adjusted to allow connection of the second end of the cable to the second structure. Second end laying and connecting apparatus for facilitating the laying and connecting of cable between first and second structures is also provided.

The present invention relates to a method of laying and connecting cable between first and second structures, particularly, but not exclusively, first and second subsea or other sub-aqua structures such as turbine towers. Cable laying and connecting apparatus is also provided.

It is often necessary to lay cables between subsea structures. One example of when this might be necessary is when connecting a pair of offshore turbine towers to one another by way of an electrical power and/or communications cable.

Furthermore, since such turbines are often installed on the seabed in an array of several turbines interconnected with one another, and to a distribution grid, there is a requirement for efficiency, speed and reliability in the process of providing cabled connection between several offshore structures.

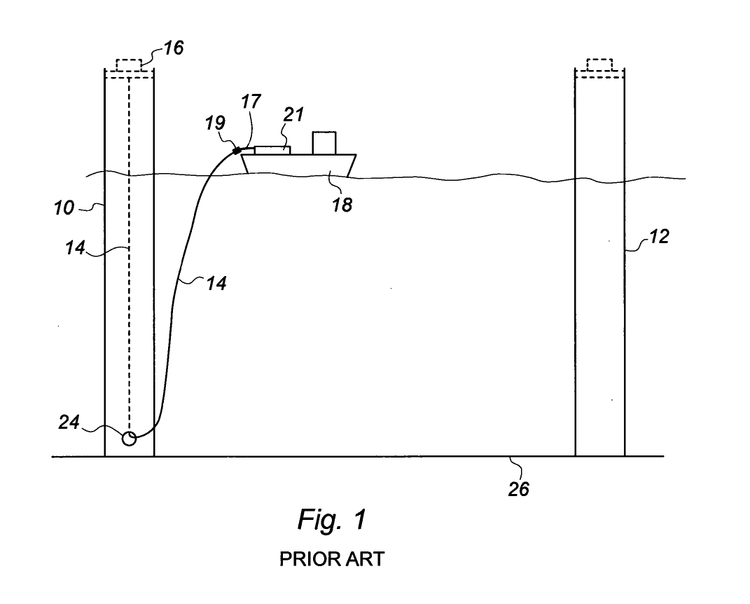

With reference to FIGS. 1 to 6, an existing prior art method of connecting a first offshore turbine tower 10 to a second offshore turbine tower 12 involves first connecting a messenger wire 14 suspended from a winch 16 of the first tower 10 to the first end of a power cable 17 on a surface vessel 18. The cable 17 is provided on a cable reel 21 or other similar storage facility (such as a carousel or tank for example). A connection 19 is provided at the junction between the messenger wire 14 and the cable 17. The connection 19 may comprise any suitable mechanism and may include, for example, a swivel joint module connected to a shackle arrangement.

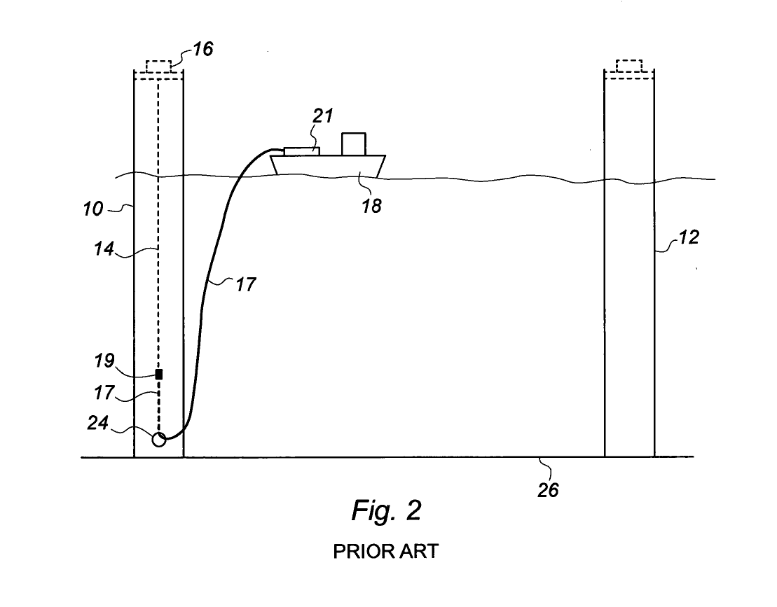

With reference to FIG. 2, in a second stage of connection, the messenger wire 14 is winched in by the winch 16 in order to progress the cable 17 from the vessel 18 and into the base of the tower 10 via a cable feed aperture 24 provided through the base of the tower 10 such that the first end of the cable 17 is progressed up toward the other electrical/communications components (not shown) of the turbine arrangement.

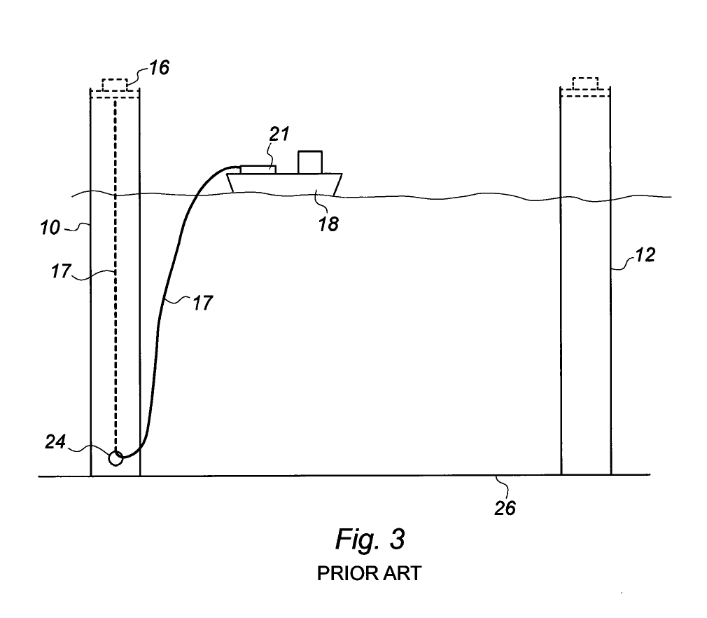

With reference to FIG. 3, continued winching of the messenger wire 14 allows the cable 17 to be progressed up the length of the first tower 10 in order to allow subsequent connection to other components of the turbine arrangement. This can include suspending the cable 17 from a hang-off arrangement and/or connecting the cable to electrical/communications components of the turbine arrangement.

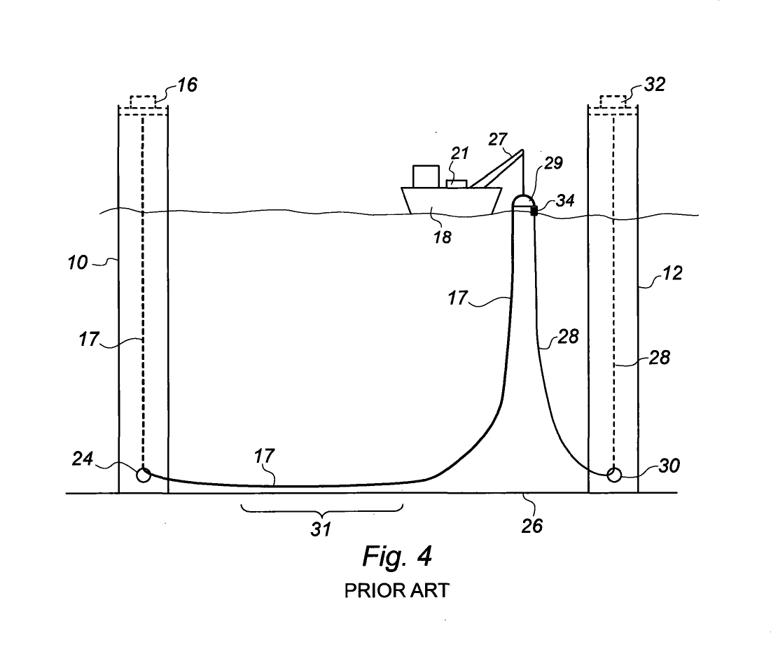

With reference to FIG. 4, now that connection has been established between the first end of the cable 17 and the first tower 10, the vessel 18 is sailed toward the second tower 12 whilst paying out cable from the reel 21 on board the vessel 18. The vessel 18 thereby lays a trail of cable 31 on the seabed 26 between the first and second towers 10, 12. Once the vessel 18 is in the vicinity of the second tower 12 the vessel will typically reverse into a position more suited to further working of the deployed cable 17 suspended therefrom. At the same time, support for the length of deployed cable 17 is then transferred from the cable reel assembly 21 to a deck mounted crane assembly 27 having a second end quadrant arrangement 29 suspended therefrom. This allows a messenger wire 28 winched out from the winch 32 of the second tower 12 to be connected to the second end of the cable 17 at a connection 34 adjacent the second end quadrant 29.

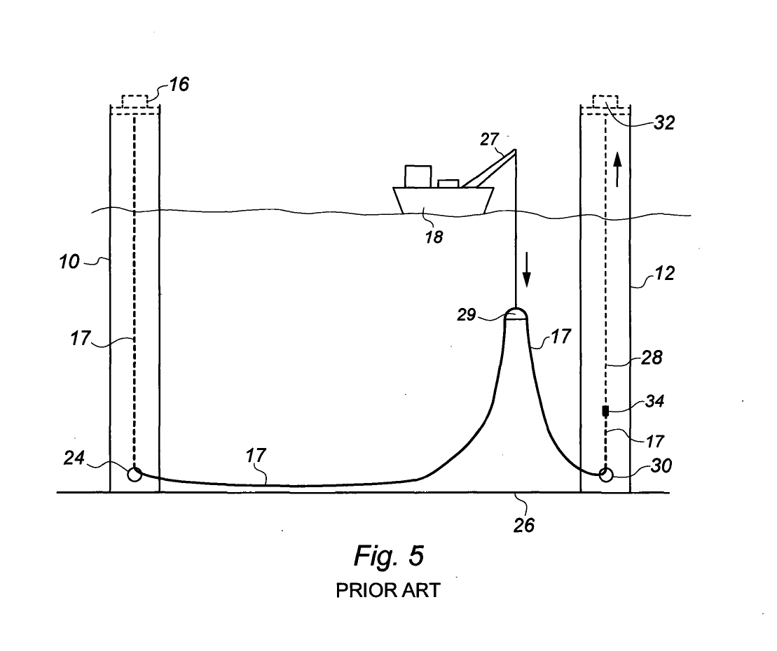

With reference to FIG. 5, in a final connection stage, the winch 32 on the second tower 12 begins to winch in the messenger wire 28 at the same time as the second end quadrant is lowered toward the sea bed 26 by the vessel's crane 27. As this occurs, the second end of the cable 17 is pulled into the base of the second tower 12 via the cable feed aperture 30 through its base until the second end of the cable 17 is finally able to be connected to the other electrical/communications components of the second turbine.

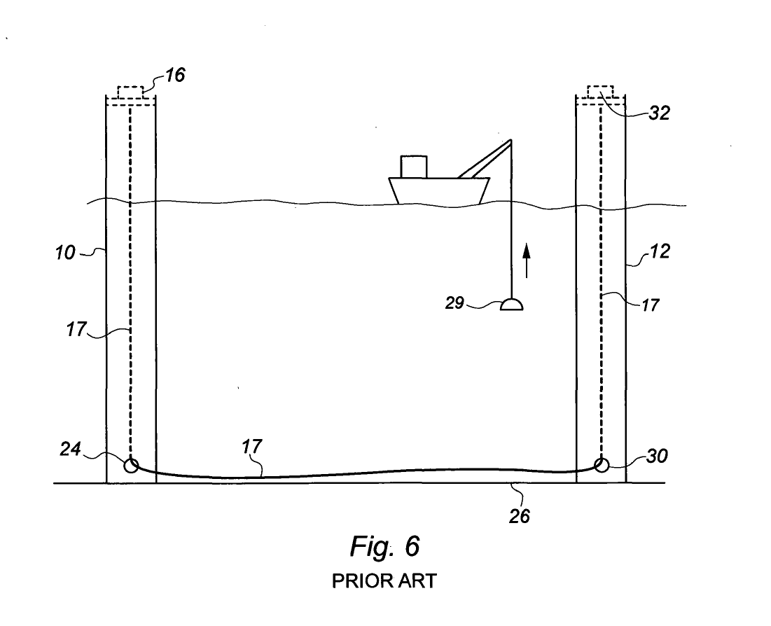

With reference to FIG. 6, the cable 17 is now connected between the two towers 10 and 12 and the second end quadrant 29 is “tripped” in order to remove the cable therefrom such that the second end quadrant 29 can be recovered to the surface by the vessel 18.

The previously described prior art method of connecting subsea structures has several problems associated with it. For example, the entire operation must be completed in satisfactory weather conditions; a difficult task since the window of suitable weather in such environments is typically relatively short meaning that expensive delays can often occur. In an attempt to address this, the vessel 18 will often hand-off the second end to a second vessel or alternatively lay the cable on the seabed for pick up and installation at a later stage by a second vessel (not shown) in order to accelerate the laying and connecting process. Although this is more economic than making use of a single vessel, since the speed of installation is increased, it does still require the expense of having two vessels present during the connecting operation.

Another problem with many existing systems is that personnel need to be shuttled on and off the towers during the various stages of connection to assist with the connection operation. Health and safety concerns make such movement of personnel especially difficult when the window of suitable weather conditions is short, especially since this is typically performed by small tender craft. It is therefore desirable to minimise the number of such transfers as well as the duration that personnel are required on the towers.

According to a first aspect of the present invention there is provided a method of laying and connecting cable between a first structure and a second structure, the method comprising:

providing a first end of the cable for connection to the first structure;

providing the second structure with a second end laying mechanism for engagement with a second end portion of the cable, wherein the second end laying mechanism is supported by the second structure;

engaging a second end portion of the cable with the second end laying mechanism to form a catenary of cable at one side of the second end laying mechanism between the first and second structures, and a tail section at the other side of the second structure and adjusting the height of the second end laying mechanism to allow connection of the second end of the cable to the second structure.

The method may also include connecting a first end of the cable to the first structure prior to, or subsequent to, engaging a second end portion of the cable with the second end laying mechanism.

The method may also comprise positioning the second end laying mechanism in a lowered configuration initially and then raising the second end laying mechanism to suspend the catenary of cable at one side of the second end laying mechanism between the first and second structures and the tail section at the other side of the second structure and then lowering the second end laying mechanism to allow connection of the second end of the cable to the second structure.

The method may also comprise providing the first and second structures mounted on a sea bed and wherein the cable is engaged with the second end laying mechanism by trailing the cable from a surface vessel.

The method may also comprise attaching one end of a messenger wire to the second end of the cable and the other end of the messenger wire to a winch mechanism provided on the second structure, and suspending both the messenger wire and the cable from the surface vessel during engagement of the second end portion of the cable with the lowered second end laying mechanism and then releasing the tail section of the second end of the cable and the attached messenger wire to the seabed.

The step of raising the second end laying mechanism may also comprise the step of retrieving the messenger wire on the winch mechanism in order to pull the second end of the cable toward the second structure.

The step of retrieving the messenger wire may also comprise providing a cable feed aperture toward the bottom of the second structure and retrieving the messenger wire through said cable feed aperture into the body of the second structure during raising of the second end laying mechanism.

The step of lowering the second end laying mechanism may also be performed once a sufficient length of the messenger wire has been retrieved by the winch, and continuing to retrieve the messenger wire and the attached second end of the cable by way of the winch during lowering of the second end laying mechanism until the messenger wire has been fully retrieved by the winch mechanism and hence the second end of the cable is adjacent an anchor point of the second structure for connection there to or suspension there from.

The method may also comprise activating a tripping arrangement on the second end laying mechanism in order to disengage the second end of the cable therefrom.

The step of lowering the second end laying mechanism may also involve allowing the winch of the second structure to passively lower the second end laying mechanism under the messenger wire and cable retrieving action of the winch.

The step of lowering the second end laying mechanism may also involve actively moving the winch of the second structure by way of a dedicated motor, winch, ballast or other actuation mechanism.

According to a second aspect of the present invention, there is provided second end laying and connecting apparatus for facilitating the laying and connecting of cable between first and second structures, the apparatus comprising:

an elevator member supported by the second structure and adapted to move on the second structure between a lowered and a raised configuration and wherein the elevator member is provided with a cable engaging portion adapted to engage with and support a second end portion of the connecting cable during connection of the cable between the first and second structures.

The cable engaging portion of the elevator member may comprise a horn member projecting outwardly from a base portion of the elevator member.

The horn member may also be provided with an upturned end in order to facilitate retention of the cable thereon during cable laying and connection operations.

The horn member may also be provided with friction control means in order to control movement of the cable over the surface of the horn during raising and lowering of the elevator member.

The horn member may also provided with a tripping mechanism adapted to selectively release the cable therefrom.

The tripping mechanism may comprise a rotating horn member such that the upturned section of the horn member may be selectively inverted.

The base portion of the elevator member may be profiled to coincide with the outer profile of the second structure to which it is mounted.

The elevator member may also comprise at least a magnetic portion adapted to retain the elevator member in close proximity with the second structure during movement between its lowered and raised configurations.

The apparatus may also comprise at least a guide cable connected toward the top of the second structure at a first end and connected toward the bottom of the structure at its other end in order to guide movement of the elevator member between its upper and lower configurations.

The base member of the elevator member may also comprise a guide cable aperture through which the guide cable passes during movement of the elevator member.

The apparatus may also comprise a pair of guide cables provided at either side of the escalator member.

The apparatus may also comprise a gravity foundation provided on the seabed and wherein the bottom of the or each guide cable is attached thereto.

The escalator may also be provided with a dedicated motor, winch, ballast or other actuation mechanism to facilitate actuation between its lowered and raised configurations.

Further features and advantages of the aspects of the present invention will become apparent from the claims and the following description.

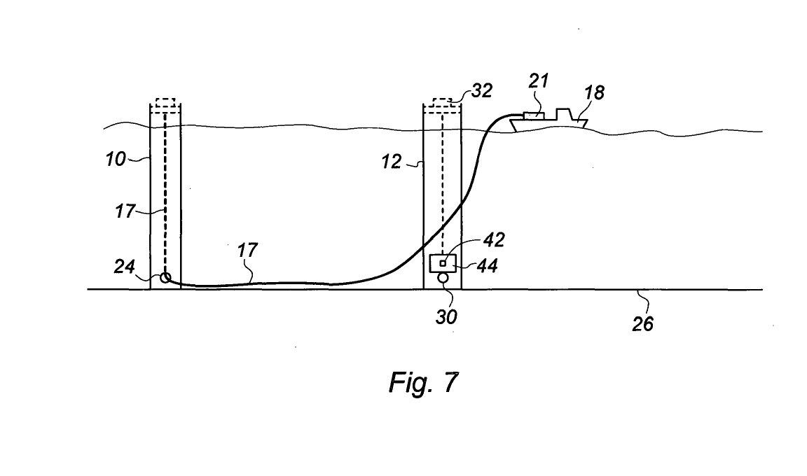

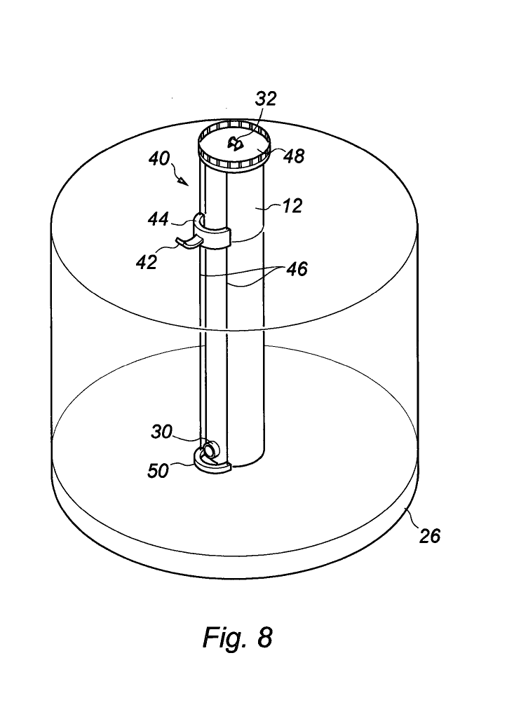

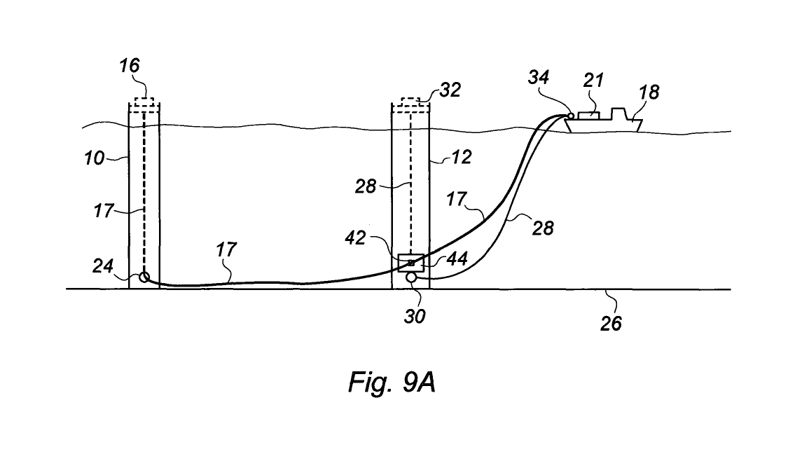

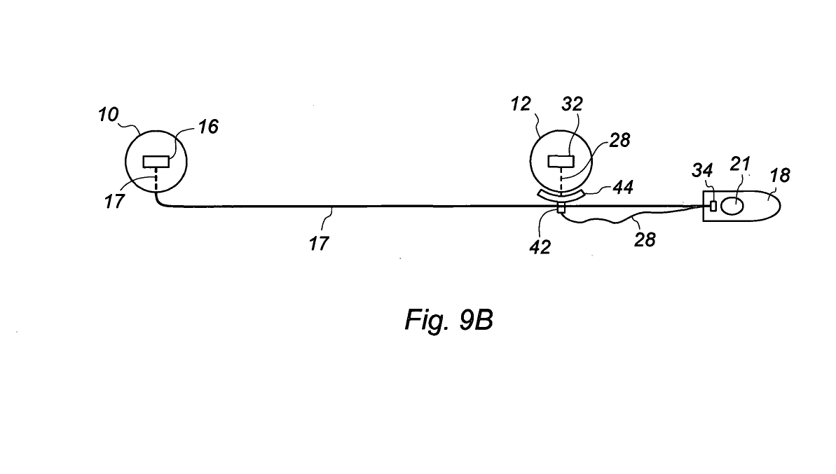

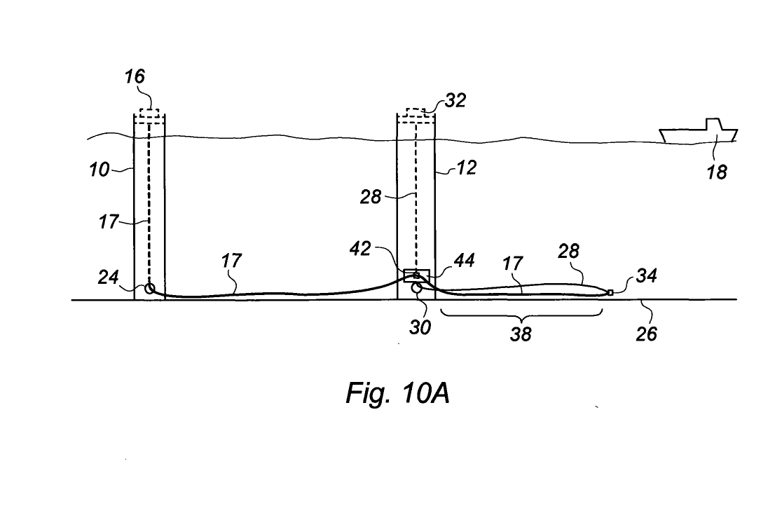

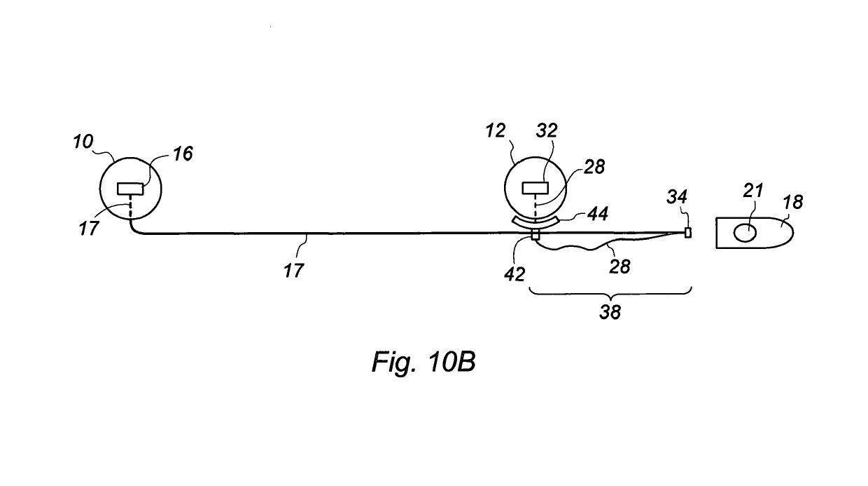

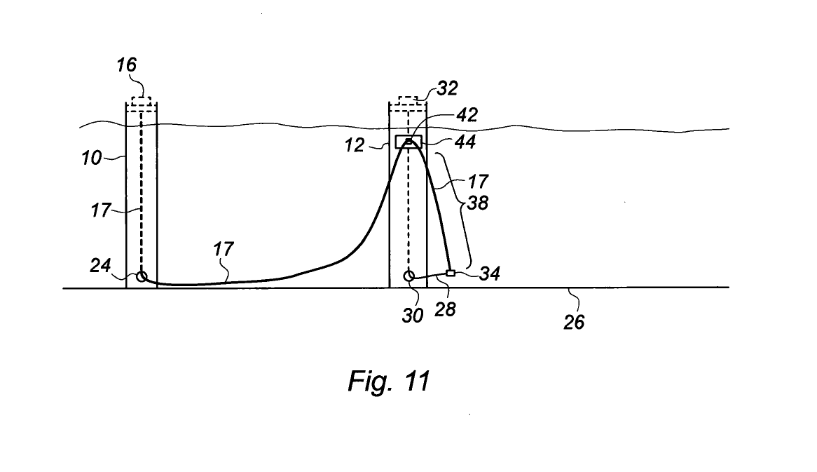

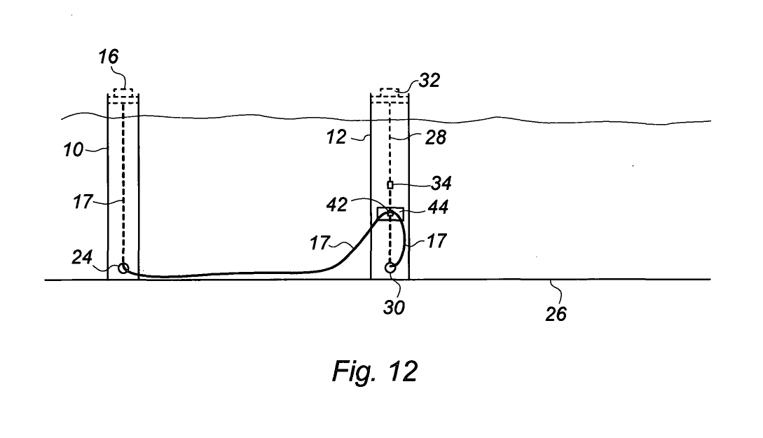

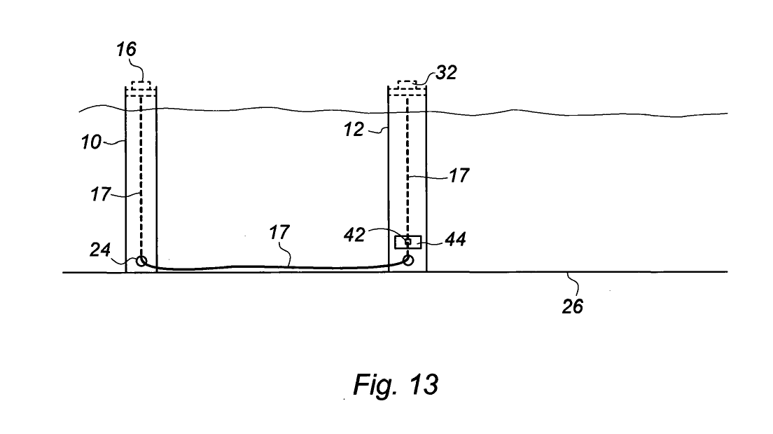

Embodiments of the present invention will now be described by way of example only, with reference to the following diagrams, in which:
FIG. 7 is a schematic illustration of a first and second offshore turbine tower where a vessel which trails a second end of a power cable connected to a first tower has sailed toward a second tower for subsequent connection thereto;
FIG. 8 is a schematic perspective illustration of a cable laying arrangement of the present invention mounted on a second offshore turbine tower, where the elevator member is in a raised position;
FIG. 9A is a schematic transverse illustration of a first and second offshore turbine tower where a power cable has previously been connected to the first tower and where a surface vessel has positioned the cable into engagement with the cable laying arrangement of the second tower;
FIG. 9B is a schematic plan view illustration of the arrangement shown in FIG. 9A;
FIG. 10A is a schematic transverse illustration of the arrangement where the surface vessel has released the cable and an associated messenger wire to the seabed to create a main section of cable between the two towers and a tail section of cable running past the second tower;
FIG. 10B is a schematic plan view illustration of the arrangement shown in FIG. 10A;
FIG. 11 is a schematic illustration of the arrangement shown in FIG. 10A, where an elevator member of the cable laying arrangement has raised the tail section for subsequent retrieval into the second tower;
FIG. 12 is a schematic illustration of the arrangement shown in FIG. 11, with the elevator member being lowered in synchronisation with the messenger wire of the second tower being winched in order to retract the tail section into the tower; and
FIG. 13 is a schematic illustration of the connected first and second towers.

When it is desired to connect first and second subsea, or more generally sub-aqua, structures (such as first and second offshore turbine towers) a power/communications cable 17 is first connected with the first tower 10. This is achieved by following the initial steps of the prior art methodology described above with reference to FIGS. 1 to 3; however, only up to the point at which the first end of the power cable 17 is connected to the first tower 10 (i.e. the stage illustrated in FIG. 3).

Alternatively, the cable 17 may be laid or otherwise located in the vicinity of the first tower 10 for subsequent connection thereto. This may be useful if weather conditions are not amenable to initial connection of the first end of cable 17 to the first tower 10. This also introduces additional procedural flexibility into the connection and laying process since the first tower 10 does not need to be ready to accept connection of the cable first end in order to carry out the other steps of the connecting method.

With reference to FIG. 7, the surface vessel 18 and its trailing cable 17 are then sailed past the second tower 12. With reference to FIG. 8, in preparation for connection of the cable second end to the second tower, a second end laying mechanism, generally designated 40, is provided on the second tower 12 and comprises a cable engaging portion in the form of an upturned horn section 42 which is mounted on an elevator member 44. The elevator member 44 is shaped according to the outer profile of the tower 12 and is mounted on a pair of vertical guide wires 46 at either side thereof which extend between an upper deck 48 and a temporary gravity foundation 50 which rests on the surface of the seabed 26. The upturned horn section 42 has a profile which ensures that the bend radius parameters of the cable are 17 are not exceeded. This arrangement allows the elevator member 44 to be raised or lowered on the tower 12 as required. Depending upon requirements, this may be achieved by a separate winch mechanism on the second tower and/or a winch mechanism integrated into the guide wires 46. This movement can alternatively be provided or facilitated by way of ballast control integrated within the elevator member 44.

With reference to FIGS. 9A and 9B, with the elevator member 44 in its lowered configuration toward the base of the tower 12 and with the first end of the cable 17 having been connected to the first tower 10, the vessel 18 and its catenary of cable 17 trailing therefrom is then sailed further past the second tower 12 whilst the vessel 18 continues to pay out cable 17 from its reel 21 in order to rest the cable 17 upon the upturned horn section 42 of the elevator member 44. The messenger wire 28 of the second tower 12 is also routed down through the second tower 12, out through the cable feed aperture 30 and picked up by the vessel 18 for connection with the second end of the cable 17 at connection 34.

Once a sufficient length of cable 17 has been paid out past the second tower 12, the cable 17 and attached messenger wire 28 is then released from the vessel 18 such that they will then rest on the seabed in a tail section depicted in FIGS. 10A and 10B as section 38. As best illustrated in FIG. 10B, the physical properties of typical suitable power/communication cables ensures that the tail section 38 naturally tends to align itself generally in line with the longitudinal axis of the main section of cable running between the first and second towers 10, 12. From this point in the cable laying and connecting operation, the vessel 18 is no longer required and is therefore freed up for use in other operations. It should be noted that, unlike many prior art systems, the tower need not be manned during the abovementioned operations (although subsequent operations may require manning of the tower).

With reference to FIG. 11, preferably while the second tower 12 is manned, the elevator member 44 is then raised towards the surface. This creates a catenary of cable 17 on one side of the second tower 12 (between the first and second towers 10, 12) and suspends the tail section 38 from the other side of the second tower 12.

With reference to FIG. 12, the winch 32 of the second tower 12 is now winched in gradually in order to first pull the tail section of cable 17 toward the body of tower 12 by way of messenger wire 28 whilst at the same time gradually lowering the elevator member 44. Continued lowering of the elevator member 44 is matched by continued winching in of the messenger wire 28 in order to progress the second end of the cable 17 through the cable guide aperture 30 and upwards through the base of the second tower 12.

Friction control means may also be provided in order to restrain the cable 17 such that the section of cable 17 between the two towers 10, 12 is not pulled over the horn section 42 whilst the elevator member 44 is lowered but that only the tail section 38 is pulled through the cable feed aperture 30. This friction control means may comprise a cable mattress or other suitable arrangement.

Lowering of the elevator member 44 may be achieved in a number of ways. For example, this may be an active arrangement whereby a dedicated mechanical elevator winch or ballast control mechanism is provided in order to forcibly lower the elevator member 44 whilst the tower winch 32 pulls the cable 17 through the cable feed aperture 30. Alternatively, an automatic/passive arrangement may be provided whereby the elevator member 44 is moved by the pulling force of the tower winch 32 acting thereon. In such an arrangement, the cable feed aperture 30 may be adapted to facilitate smooth movement of the cable 17 therethrough without exceeding the cable bend radius parameters.

With reference to FIG. 13, once the elevator member 44 has been fully lowered (or lowered to a suitably low height from the sea bed 26) and the cable 17 fully retracted into the second tower 12, the horn section 42 of the elevator member 44 is “tripped” or otherwise actuated in order to release the portion of cable 17 previously supported thereby. This release of the cable 17 from the horn section 42 may be achieved in a number of different ways. For example, the horn section 42 may be rotated, retracted or hinged out of engagement with the cable 17 by a mechanical, buoyancy controlled or other actuating mechanism in order to release the cable 17 therefrom.

Once the above steps have been completed, the second end of the cable 17 can now be connected to the other components of the second turbine tower 12 such that cabled connection is established between the first and second towers.

With reference to FIG. 8, it should be noted that the components of the cable laying arrangement 40 are designed such that they may be removed from the tower once the laying and connecting operation has been completed. To facilitate this, the pair of vertical guide cables 46 are suspended between anchor points on the underside of the deck 48 and corresponding anchor points provided on the gravity foundation 50. This allows the vertical guide cables 46, attached elevator member 44, and the gravity foundation 50 to be removed once the connecting operation is complete such that they may be reused on another tower during the next connecting operation.

The method and apparatus of the invention provide several significant advantages over prior art methods of connecting subsea structures. These include, but are not limited to, the following:
The method typically only requires a single vessel to complete the laying and connecting operation. Since vessels equipped for such operations are typically very expensive to lease, operate and maintain, the invention provides a significant cost saving over previous laying and connecting methods.
Fewer steps in the process are dependent upon good weather conditions when compared to prior art methods. This is because much of the process is carried out subsea rather than by a surface vessel (which is more susceptible to adverse weather conditions).
Since the cable laying arrangement is securely attached to the subsea structure, which itself is firmly installed on the seabed, the speed at which the operation can be completed is increased since there is less opportunity for cable misalignment issues etc. This makes the method and equipment more efficient and more reliable than prior art methods and equipment.
Less equipment and deck space is required on the vessel itself in view of the simplified nature of the laying and connecting operation insofar as it involves the surface vessel and since no second end quadrant is required to be moved across the deck space of the vessel.

Although particular embodiments of the invention have been disclosed herein in detail, this has been done by way of example and for the purposes of illustration only. The aforementioned embodiments are not intended to be limiting with respect to the scope of the appended claims.

It is contemplated by the inventors that various substitutions, alterations, and modifications may be made to the invention without departing from the spirit and scope of the invention as defined by the claims. Examples of these include the following:

Although the method is described with reference to connecting first and second offshore turbine towers, the method could alternatively be used to connect any submerged structures. For example, it could be used to connect one oil/gas platform to another.

The elevator member 44 may be provided with a magnetic retaining arrangement to hold it in close relationship with the tower structure during movement along the vertical guide wires.

The upturned horn section 42 and/or elevator member 44 may be provided with a selectively engageable friction control means and/or cable clamp arrangement in order to control the direction and rate of slippage for the cable resting on the horn section 42 during the various different stages of laying and connection.

1. A method of laying and connecting cable between a first structure and a second structure, the method comprising:
providing a first end of the cable for connection to the first structure;
providing the second structure with a second end laying mechanism for engagement with a second end portion of the cable, wherein the second end laying mechanism is supported by the second structure;
engaging the second end portion of the cable with the second end laying mechanism to form a catenary of cable at one side of the second end laying mechanism between the first and second structures-, and a tail section at the other side of the second structure, and adjusting height of the second end laying mechanism to allow connection of the second end of the cable to the second structure.

2. A method according to claim 1, further comprising the step of connecting the first end of the cable to the first structure.

3. A method according to claim 1, further comprising positioning the second end laying mechanism in a lowered configuration initially and then raising the second end laying mechanism to suspend the catenary of cable at one side of the second end laying mechanism between the first and second structures and the tail section at the other side of the second structure and then lowering the second end laying mechanism to allow connection of the second end of the cable to the second structure.

4. A method according to claim 1, wherein the first and second structures are mounted on a sea bed and wherein the cable is engaged with the second end laying mechanism by trailing the cable from a surface vessel.

5. A method according to claim 4, further comprising attaching one end of a messenger wire to the second end of the cable and the other end of the messenger wire to a winch mechanism provided on the second structure, and suspending both the messenger wire and the cable from the surface vessel during engagement of the second end portion of the cable with the lowered second end laying mechanism and then releasing the tail section of the second end of the cable and the attached messenger wire to the seabed.

6. A method according to claim 5, wherein the step of raising the second end laying mechanism further comprises the step of retrieving the messenger wire on the winch mechanism in order to pull the second end of the cable toward the second structure.

7. A method according to claim 6, wherein the step of retrieving the messenger wire comprises providing a cable feed aperture toward a bottom of the second structure and retrieving the messenger wire through said cable feed aperture into a body of the second structure during raising of the second end laying mechanism.

8. A method according to claim 7, wherein the step of lowering the second end laying mechanism is performed once a sufficient length of the messenger wire has been retrieved by the winch, and continuing to retrieve the messenger wire and the attached second end of the cable by way of the winch during lowering of the second end laying mechanism until the messenger wire has been fully retrieved by the winch mechanism and hence the second end of the cable is adjacent an anchor point of the second structure for connection there to or suspension there from.

9. A method according to claim 8, further comprising activating a tripping arrangement on the second end laying mechanism in order to disengage the second end of the cable therefrom.

10. A method according to claim 8, wherein the step of lowering the second end laying mechanism involves allowing the winch of the second structure to passively lower the second end laying mechanism under the retrieving action of the winch acting on the messenger wire and cable.

11. A method according to claim 8, wherein the step of lowering the second end laying mechanism involves actively moving the winch of the second structure by a member selected from the group consisting of a dedicated motor, winch, ballast, variable buoyancy and other actuation mechanism.

12. Second end laying and connecting apparatus for facilitating laying and connecting of cable between first and second structures, the apparatus comprising:
an elevator member supported by the second structure and adapted to move on the second structure between a lowered and a raised configuration and wherein the elevator member is provided with a cable engaging portion adapted to engage with and support a second end portion of the connecting cable during connection of the cable between the first and second structures.

13. Apparatus according to claim 12, wherein the cable engaging portion of the elevator member comprises a horn member projecting outwardly from a base portion of the elevator member.

14. Apparatus according to claim 13, wherein the horn member is provided with an upturned end in order to facilitate retention of the cable thereon during cable laying and connection operations.

15. Apparatus according to claim 13, wherein the horn member is provided with friction control means for controlling movement of the cable over a surface of the horn during raising and lowering of the elevator member.

16. Apparatus according to claim 13, further comprising a clamping mechanism for selectively securing the cable against movement relative to the elevator member.

17. Apparatus according to claim 13, wherein the horn member is provided with a tripping mechanism adapted to selectively release the cable therefrom.

18. Apparatus according to claim 17, wherein the tripping mechanism comprises a rotating horn member such that an upturned section of the horn member may be selectively inverted.

19. Apparatus according to claim 13, wherein the base portion of the elevator member is profiled to coincide with an outer profile of the second structure to which it is mounted.

20. Apparatus according to claim 12, wherein the elevator member comprises at least a magnetic portion adapted to retain the elevator member in close proximity with the second structure during movement between its lowered and raised configurations.

21. Apparatus according to claim 12, further comprising at least a guide cable connected toward a top of the second structure at a first end and connected toward a bottom of the structure at its other end in order to guide movement of the elevator member between its upper and lower configurations.

22. Apparatus according to claim 21, wherein a base member of the elevator member comprises a guide cable aperture through which the guide cable passes during movement of the elevator member.

23. Apparatus according to claim 22, wherein the guide cable aperture is provided at either side of the elevator member.

24. Apparatus according to claim 21, wherein a gravity foundation is provided on a seabed and wherein a bottom of each guide cable is attached thereto.

25. Apparatus according to claims 12, wherein the elevator is provided with a member selected from the group consisting of a dedicated motor, winch, ballast and other actuation mechanism to facilitate actuation between its lowered and raised configurations.

26. A structure for use with the apparatus of claim 12, wherein the structure is provided with a cable feed aperture through a portion thereof in order to allow a messenger wire and a cable second end to be passed therethrough during cable laying and connecting operations.

27. A structure according to claim 26, wherein the cable feed aperture comprises friction reducing means to facilitate movement of the cable therethrough.

28. (canceled)

29. (canceled)
